(19) United States
(12) Patent Application Publication
(10) Pub. No.: US 2020/0238568 A1
(43) Pub. Date: Jul. 30, 2020

(54) HOMOGENIZER AND SCREEN SUPPORT FOR EXTRUSION

(71) Applicant: CORNING INCORPORATED, Corning, NY (US)

(72) Inventors: James Joseph Bernas, Horseheads, NY (US); Thomas William Brew, Corning, NY (US); Jason Nelson Brown, Corning, NY (US); Steven John Kremer, Big Flats, NY (US); Kenneth Charles Sariego, Beaver Dams, NY (US)

(21) Appl. No.: 16/776,830

(22) Filed: Jan. 30, 2020

Related U.S. Application Data
(60) Provisional application No. 62/798,597, filed on Jan. 30, 2019.

(51) Int. Cl. B28B 3/20; B28B 3/26; B01J 35/04; B01D 46/24

(52) U.S. Cl. CPC B28B 3/206; B28B 3/269; B28B 2003/203; B01D 46/2418; B01J 35/04

(57) ABSTRACT

Ceramic honeycomb extrusion apparatus and a method of extruding a honeycomb body are disclosed. The honeycomb extrusion apparatus and method utilize a homogenizer plate comprising through holes and a screen support plate comprising screen support plate openings and aligned with the through holes.

This application claims the benefit of priority under 35 U.S.C. § 119 of U.S. Provisional Application No. 62/798,597 filed on Jan. 30, 2019, the content of which is incorporated herein by reference in its entirety.

### FIELD

The present disclosure relates generally to the manufacture of extruded honeycomb bodies of ceramic or ceramic-forming material which are suitable for making into ceramic honeycomb bodies, such as for catalytic converters, particulate filters, and other components, such as for engine exhaust treatment.

### BACKGROUND

Various methods and devices are known for reducing emissions of engine exhaust, including catalyst supports or substrates. Catalytic converters are used to remove pollutants from hot exhaust gases discharged from an internal combustion engine, for example in automobiles including passenger cars, light duty trucks, heavy duty trucks and industrial equipment. A catalytic converter can include a substrate in the form of a honeycomb body and may be of a ceramic material, having channels through which exhaust gases flow. The honeycomb body can contain catalyst which functions to convert the hydrocarbons (HC), carbon monoxide (CO) and nitric oxide (NOₓ) and help purify the exhaust gases.

Honeycomb bodies can be formed by a twin screw extrusion process which can extrude structures of complex cross-section from plasticized mixtures of inorganic powders and suitable binders as disclosed in U.S. Pat. No. 4,551,295 to Gardner et al. In this process a batch mixture consisting of inorganic clay, talc and alumina powders is combined with organic binders and water, and the resulting mixture is plasticized in the extruder. The plasticized batch mixture is then fed to a honeycomb extrusion die mounted on the end of the extruder.

There is an ongoing need to provide improvements to processes and apparatus for extruding green ceramic-forming honeycomb bodies. Thus, there is a need to provide improved apparatus and methods that utilize a homogenizer.

### SUMMARY

A first aspect of the present disclosure relates to a honeycomb extrusion apparatus for making extrudate of ceramic-forming material, the apparatus comprising a honeycomb extrusion die having an inlet face comprising feed holes and an outlet face comprising discharge openings, the discharge openings configured to form a honeycomb extrudate from a stream of material flowing through the honeycomb extrusion die; a homogenizer plate positioned upstream from the inlet face of the extrusion die, the homogenizer plate comprising a homogenizer plate inlet side, a homogenizer plate outlet side and a plurality of through holes extending through the homogenizer plate, each of the through holes surrounded by frame material; a screen support plate positioned upstream and adjacent to the homogenizer plate inlet side, the screen support plate comprising a screen support plate inlet side, a screen support plate outlet side, and a plurality of screen support plate openings extending through the screen support plate, wherein the plurality of screen support plate openings are configured to align with the through holes extending through the homogenizer plate, comprise a greater number of screen support plate openings than the plurality of through holes extending through the homogenizer plate and wherein the screen support plate openings do not overlap with the homogenizer plate frame material; and a screen positioned upstream and adjacent to the screen support inlet side, the screen comprising a screen inlet side and a screen outlet side.

A second aspect of the disclosure pertains to a method of extruding to make a ceramic-forming extrudate for making a ceramic honeycomb body, the method comprising directing a feed stream of batch material along an extrusion path through a screen supported by a screen support plate and then through a homogenizer plate, wherein the homogenizer plate comprises a homogenizer plate inlet side, a homogenizer plate outlet side and a plurality of through holes extending through the homogenizer plate, and the screen support plate is positioned upstream and adjacent to the homogenizer plate inlet side, the screen support plate comprising a screen support plate inlet side, a screen support plate outlet side, and a plurality of screen support plate openings extending through the screen support plate, wherein the plurality of screen support plate openings are configured to align with the through holes extending through the homogenizer plate and comprise a greater number of screen support plate openings than the plurality of non-circular through holes extending through the homogenizer plate.

### BRIEF DESCRIPTION OF THE DRAWINGS

FIG. 1 shows an exemplary embodiment of a honeycomb body that can be made by the apparatus and methods of the present disclosure;

FIG. 2 is a top plan view of a known screen support plate with circular holes;

FIG. 3 is an exploded perspective view of a portion of an apparatus for manufacturing a honeycomb body according to an embodiment of the disclosure;

FIG. 4 is a cross-sectional view of an extrusion die for a honeycomb body according to an embodiment of the disclosure;

FIG. 5 shows a perspective view of a screen support plate and a homogenizer plate according to an embodiment of the disclosure;

FIG. 6 shows an exploded perspective view of the screen support plate and a homogenizer plate shown in FIG. 5;

FIG. 7 shows a top plan view of the homogenizer plate shown in FIG. 5;

FIG. 8 shows a top plan view of the screen support plate shown in FIG. 5; and

FIG. 9 shows a graph comparing homogenizer pressure in PSI for a homogenizer plate with circular holes and screen support plate and a homogenizer plate and screen support plate according to an embodiment of the disclosure.

### DETAILED DESCRIPTION

Reference will now be made in detail to the embodiments of the disclosure, examples and aspects of which are illustrated in the accompanying figures. Before describing several exemplary embodiments of the disclosure, it is to be understood that the disclosure is not limited to the details of construction or process steps set forth in the following description. The disclosure is capable of other embodiments and of being practiced or being carried out in various ways.

The manufacture of porous ceramic honeycomb bodies may be accomplished by the process of plasticizing ceramic powder batch mixtures, extruding the mixtures through honeycomb extrusion dies to form honeycomb extrudate, and cutting, and drying the extrudate to form green ceramic-forming honeycomb bodies, and firing the green honeycomb bodies to produce ceramic honeycomb bodies of high strength and thermal durability having channels extending axially from a first end face to a second end face.

A co-extruded or an after-applied exterior skin may form an outer peripheral surface extending axially from a first end face to a second end face of the ceramic honeycomb bodies. Each channel of the honeycomb bodies defined by intersecting walls (webs), whether monolithic or segmented, can be plugged at an inlet end face or an outlet end face to produce a filter. When some channels are left unplugged a partial filter can be produced. The honeycomb body, whether monolithic or segmented, can be catalyzed to produce a substrate. A non-plugged honeycomb body is generally referred to herein as a substrate. The catalyzed substrate can have an after applied catalyst or comprise an extruded catalyst. Further, filters and partial filters can be catalyzed to provide multi-functionality. The ceramic honeycomb bodies thus produced are can be used as catalysts, catalyst supports, membrane supports, wall-flow filters, partial filters, and combinations thereof.

Ceramic honeycomb body batch material compositions are not particularly limited and can comprise major and minor amounts of cordierite, aluminum-titanate, mullite, (3-spodumene, silicon carbide, zeolite and the like, and combinations thereof. As a further example, the ceramic honeycomb body can comprise an extruded zeolite or other extruded catalyst.

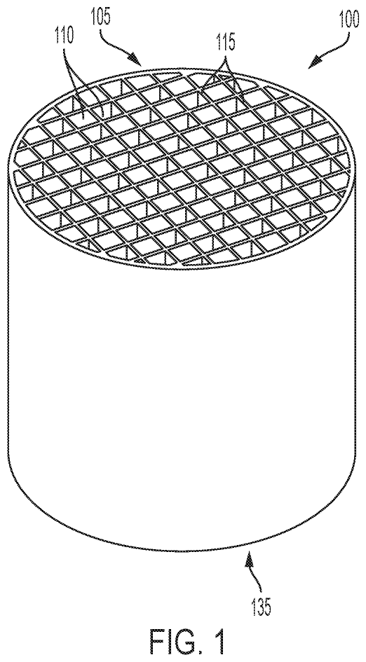

With reference now to FIG. 1, an exemplary embodiment of a honeycomb body 100 that can be manufactured using the apparatus and methods according to one or more embodiments is depicted. The honeycomb body 100 may comprise a plurality of walls 115 defining a plurality of inner channels 110. The plurality of inner channels 110 and intersecting channel walls 115 extend between first end 105 and second end 135 of the honeycomb body.

When batch material is extruded into shapes such as honeycomb bodies, screens can be used to filter the batch material before the material is pushed into and through the die. The pressure required to push this material through the homogenizer depends on the batch properties of the mixture, for example the pressure can be in a range of 500-3000 psi (3.44-20.64 MPa). Pressure drops in the extrusion line accumulate to require a maximum required driving pressure Pmax. Pmax may be the limit of the equipment, for example 5000 psi (34.47 MPa). According to embodiments of the disclosure, a large open area homogenizer is utilized, which reduces pressure in the homogenizer. Wall friction characteristics of materials used to manufacture honeycomb bodies, along with the geometric boundary conditions of a homogenizer plate can be considered in the design of the apparatus described herein, such as by a governing pressure equation P=4 Tw L/D (where Tw is the shear stress at the wall (wall drag), L is the length of the hole in the homogenizer plate, and D (or “H_{d}”) is the hydraulic diameter representative of the width of opening of the hole in the homogenizer plate). According to one or more embodiments, an increase in D of the extrusion pathway that the batch material travels through results in a pressure reduction. A reduction of pressure will result in an increase in available extrusion capacity. Effectively, the amount of batch that can be pushed through the die will increase.

During extrusion of honeycomb bodies, the extrusion pathway may include a screen upstream from a screen support plate, which is upstream from a homogenizer plate. The homogenizer plate helps to avoid or at least reduce uneven mixing of the batch material and viscosity gradients during the extrusion process. In particular, uneven mixing may generate zones of cumulative-shear non-uniformity (i.e., zones of differing shear history) within the batch, with the more extensively sheared zones tending to exhibit lower viscosity than other zones within the mixture. Because the batch may not be not evenly heated and can include regions of differing shear history, some portions of the batch fed to the extrusion die may be relatively stiff and difficult to extrude, while other, softer portions of the batch will extrude more rapidly. Each of these effects tends to decrease viscosity and increase extrusion rate at the center of the flow stream traversing the extrusion die, relative to viscosity and extrusion rate around the periphery of the flow stream. Embodiments of the present disclosure provide apparatus and processes that can help to lead to increased production and decreased cost of producing extruded ceramic honeycombs by increasing the rate of extrusion of ceramic batch materials.

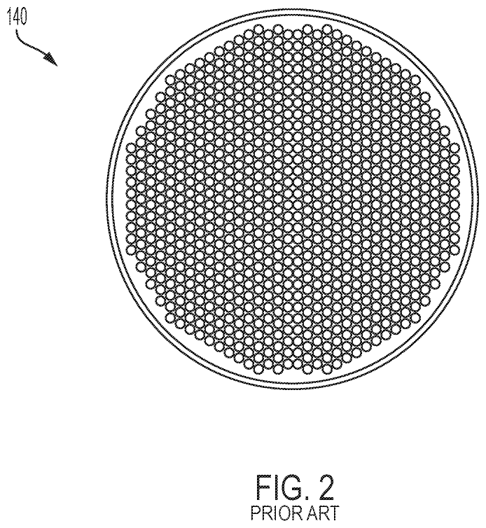

FIG. 2 shows a top plan view of a known screen support plate 220 with circular holes that can be used in an extrusion apparatus. As will be described further below, a screen, a screen support plate and a homogenizer are placed upstream from the honeycomb extrusion die in the extrusion machine, which may be a ram extruder or a twin screw extruder. The screen support plate 220 shown in FIG. 2 comprises a generally circular plate with circular screen support plate openings 224.

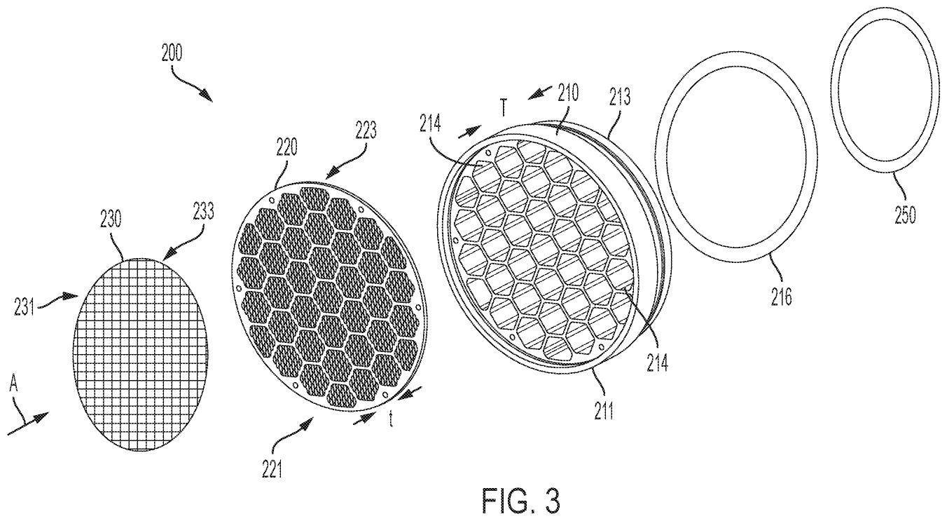

According to one or more embodiments of the present disclosure shown with respect to FIGS. 3-8 an extrusion apparatus comprises a screen support plate 220 comprising homogenizer plate openings, screen support plate 220 positioned upstream from a homogenizer plate 210 comprising homogenizer plate through-holes 214,

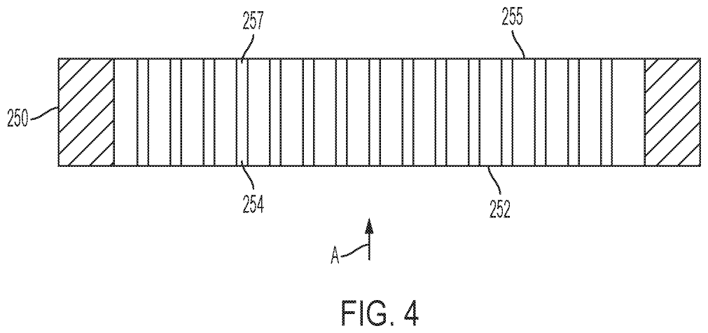

Changing the pattern of the openings in the screen support plate 220 and in the homogenizer plate through holes could reduce the pressure at the homogenizer plate. FIG. 3 shows an embodiment of a portion of an extrusion apparatus 200 that includes a honeycomb extrusion die 250 (which, for simplicity, details of the die are not shown). FIG. 4 shows a non-limiting embodiment of a honeycomb extrusion die 250 having an inlet face 252 comprising feed holes 254 and an outlet face 255 comprising discharge openings 257, the discharge openings configured to form a honeycomb extrudate from a stream of material flowing through the honeycomb extrusion die 250 when the stream of material flows in the direction indicated by arrow “A” in FIGS. 3 and 4.

The extrusion apparatus 200 shown in FIG. 3 further comprises a homogenizer plate 210 positioned upstream from the inlet face of the extrusion die 250, the homogenizer plate 210 comprising a homogenizer plate inlet side 211, a homogenizer plate outlet side 213 and a plurality of through holes 214 extending through the homogenizer plate 210. The homogenizer plate 210 may be mounted to a homogenizer holding ring 216. The extrusion apparatus 200 further comprises a screen support plate 220 positioned upstream and adjacent to the homogenizer plate inlet side 211, the screen support plate 220 comprising a screen support plate inlet side 221, a screen support plate outlet side 223, and a plurality of screen support plate openings 224 extending through the screen support plate, wherein the plurality of screen support plate openings 224 are configured to align with the through holes 214 extending through the homogenizer plate 210. The screen support plate 220 comprises a thickness “t” extending between the screen support plate inlet side 221 and the screen support plate outlet side 223.

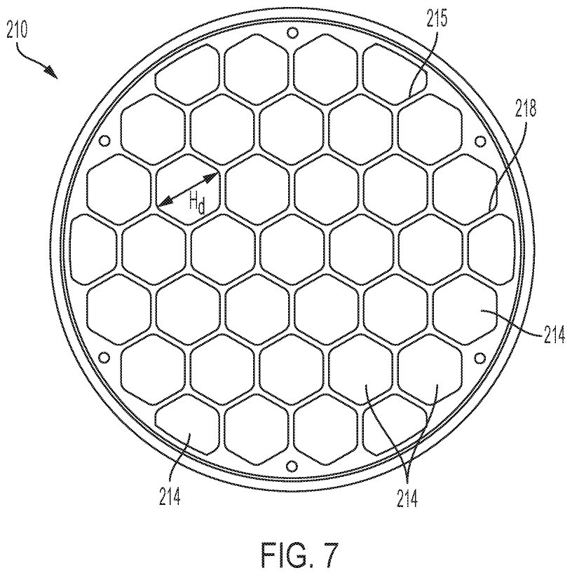

The homogenizer plate 210 shown in FIG. 3 comprises a generally circular plate that can have a thickness “T” in a range of about 1 to 3 inches (2.54-10.16 cm) with through holes 214. In one or more embodiments, the through-holes can range from 0.5 inches (1.37 cm) to 2 inches (5.08 cm) in hydraulic diameter (H_{d} in FIG. 7). In one or more embodiments, the overall diameter Dtot of each of the homogenizer plate 210 and screen support plate 220 is in range of 8-20 inches (20.32-50.8 cm). While the embodiment shown in FIG. 3 shows a single screen support plate 220, it will be understood that more than one screen support plate 220 can be utilized according to one or more embodiments in a stacked arrangement upstream from the homogenizer plate 210. Thus, in some embodiments, there is a plurality of screen support plates and the screen support plate openings in one screen support plate may have a different size than the screen support plate openings in another screen support plate.

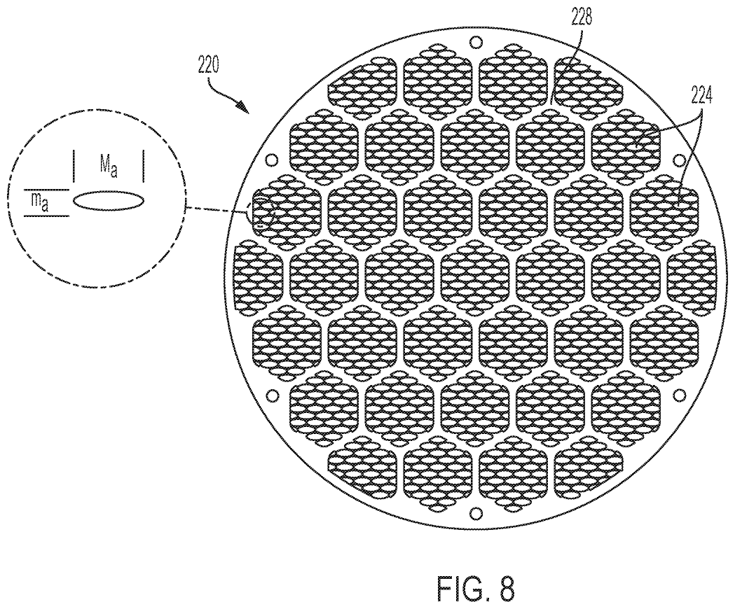

In some embodiments, the screen support plate openings 224 are non-circular in shape. In specific embodiments, the screen support openings are elliptical in shape, and each elliptical opening has a minor axis (mₐ) size of 0.15 inches (0.38 cm) and a major axis (Mₐ) size of 0.35 inches (0.89 cm) (as shown in FIG. 8). In some embodiments, the screen support plate openings 224 are spaced apart in a range of 0.28×0.33 inches (0.711-0.838 cm) on center. In one or more embodiments, the screen support plate 220 has a thickness “t” that is sufficient to prevent deformation of the screen support plate during an extrusion process. In exemplary embodiments, the screen support plate 220 comprises a thickness “t” in a range of about 0.15 to 0.5 inches (0.38-1.27 cm).

The extrusion apparatus 200 shown in FIG. 3 further comprises at least one screen 230 positioned upstream and adjacent to the screen support plate inlet side 221. The screen 230 comprises a screen inlet side 231 and a screen outlet side 233. As used herein, “downstream” refers to the location of the exiting flow of batch material as indicated by the direction “A,” and upstream refers a location that is contacted with batch material prior to the batch material flowing downstream in the direction “A.” In other words, inlet face 252 of the extrusion die 250 is upstream from the outlet face 255 of the extrusion die 250. A plurality of screens may be stacked upon (e.g. upstream of) the screen support plate 220.

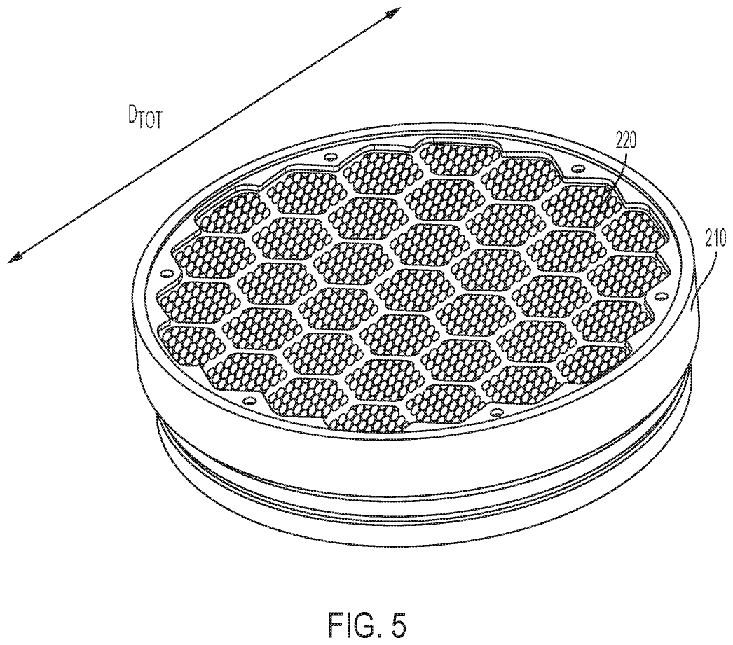

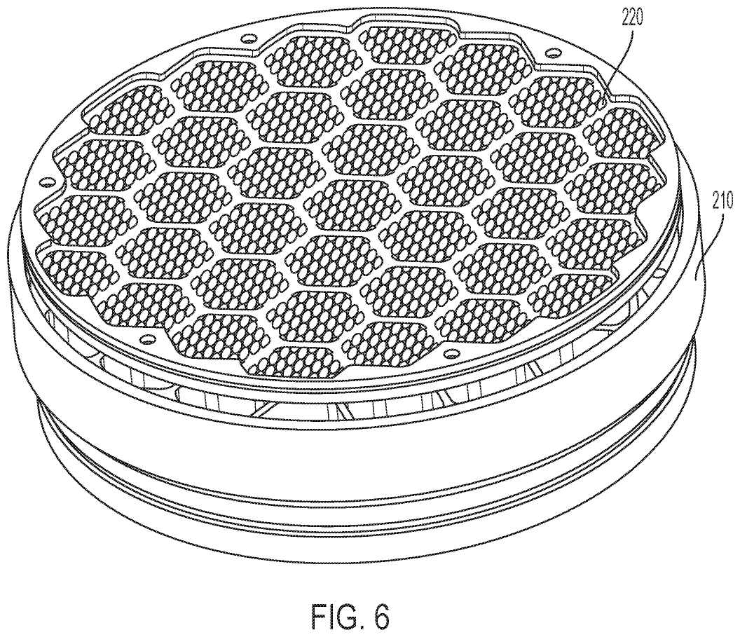

FIG. 5 shows a perspective view of the assembled homogenizer plate 210 and the screen support plate 220 (or “assembly”). FIG. 6 shows an exploded perspective view of the homogenizer plate 210 and the screen support plate 220. FIG. 7 shows a top plan view of the homogenizer plate 210, and FIG. 8 shows a top plan view of the screen support plate 220. In the embodiment shown, each of the homogenizer through holes 214 are non-circular or non-round in shape, for example, hexagonal in shape and surrounded by homogenizer plate frame material 218. In some embodiments, each of the screen support plate openings 224 are arranged so that they do not overlap with the homogenizer plate frame material 218 that surround each of the hexagonally-shaped homogenizer through holes 214. In specific embodiments, the screen support plate openings 224 are elliptical and have a major axis Mₐ and a minor axis mₐ.

In the embodiment shown, the screen support plate openings 224 are arranged in hexagonal arrays, and each array is surrounded by screen support plate frame material 228. The hexagonal arrays surrounded by screen support plate frame material 228 are arranged to align with the hexagonally-shaped homogenizer through holes 214. In some embodiments, the screen support plate openings 224 do not overlap with the homogenizer plate frame material 218. In some embodiments, only the screen support plate frame material 228 of the screen support plate 220 overlaps with the homogenizer plate frame material 218.

In some embodiments, the screen support plate 220 has an open area that is greater than a screen support plate that has circular screen support plate openings. “Open area” refers to the area defined by the openings and excludes material defining the openings. The screen support plate 220 having the plurality of screen support plate openings 224 includes a number of screen support plate openings 224, and the homogenizer plate 210 includes the plurality of homogenizer support plate through holes 214 including a number of homogenizer plate through holes 214. In some embodiments, there is a ratio of the number of screen support plate openings to homogenizer plate through holes in a range of from 4:1 to 40:1, for example in a range of from 5:1 to 40:1, in a range of from 10:1 to 40:1, in a range of from 15:1 to 40:1, in a range of from 20:1 to 40:1 and in a range of from 25:1 to 40:1.

In some embodiments, when material is extruded through the honeycomb extrusion apparatus to form a honeycomb body there is a pressure drop over the homogenizer plate that is less than a pressure drop compared to a screen support plate with circular openings and a homogenizer plate with circular through holes.

According to one or more embodiments, the apparatus reduces the pressure needed to push batch through the holes compared to an apparatus with a homogenizer plate with circular holes. In some embodiments, enlarged through holes in the homogenizer plate pathway are provided for the material to flow in a less constricted manner and a screen support plate with support plate openings is provided that are aligned with the homogenize plate through holes. A governing equation of the system (with respect to a batch sliding on the hole surface) based on the frictional characteristics of the batch and boundary conditions of the hardware imposed on the material passing through a holecan be written in terms of pressure: Pressure=4×Tw×L/D, where Tw is the shear stress at the wall (wall drag), L is the length of the hole, and D is the hydraulic diameter (or “H_{d}”) representative of the width of opening of the hole. It was discovered that the homogenizer plate and screen support plate design described herein greatly enlarges the “D” (or “H_{d}”) hydraulic diameter of the homogenizer plate through hole and therefore reduces the frictional pressure drop within a channel. Another portion of pressure drop is due to deformation or geometric contraction and expansion of the material. This pressure is seen to be a function of the area reduction and for a fluid with a yield stress, can be expressed as P=σLn(A1/A2). Where σ=yield stress, A1=inlet fluid area, A2=channel fluid area. For example, with a hexagonal design of the homogenizer and thin support material, the difference between A1 and A2 is reduced and therefore, the deformational pressure is reduced.

Modeling data indicated that, as the composition wall drag increased, the homogenizer plate and screen support design described herein enabled greater pressure reduction as wall drag increases. The open area hexagonal homogenizer plate through hole design according to some embodiments can have an opening 6 to 20 times greater in size than circular hole-drilled homogenizer plates. The screen support plate of the present disclosure compared to the screen support plate shown in FIG. 2 provides an open area gain of 138% improvement. It will be appreciated that the larger homogenizer plate through-holes required a redesign of the screen support plate to ensure the pressure during extrusion was managed to allow sufficient throughput, while also ensuring that the one or more screens did not collapse during extrusion.

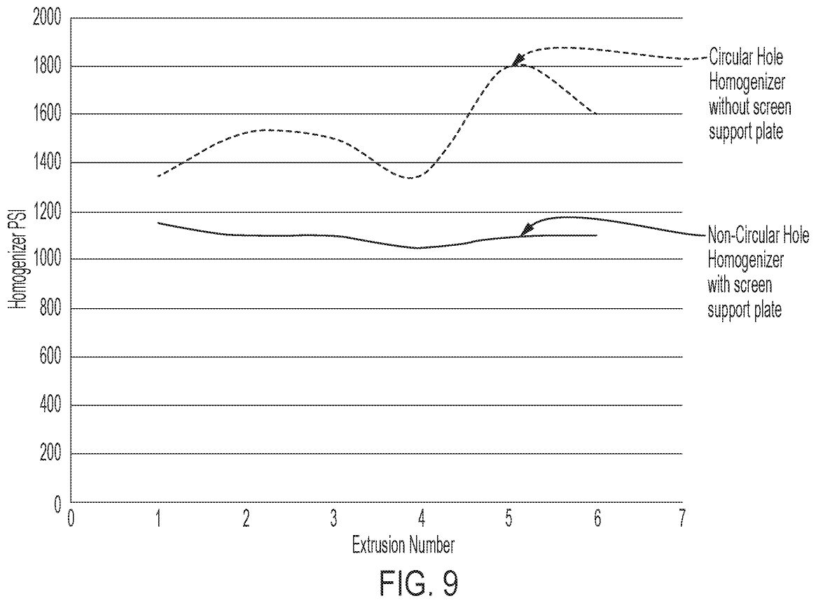

Scale testing has been conducted on a laboratory scale extruder using a portion of the screen support plate described herein and a portion of a circular hole homogenizer comprising a homogenizer plate without a screen support plate. A ceramic batch was used to extrude a honeycomb extrudate, and the results exhibited an average pressure reduction of 370 psi. FIG. 9 is graph showing small scale lab extruder testing showing the corresponding pressure drop.

Another aspect of the disclosure pertains to a method of extruding to make a ceramic honeycomb body. In a first embodiment, the method comprises directing a feed stream of ceramic-forming batch material along an extrusion path through a screen supported by a screen support plate and then through a homogenizer plate, wherein the homogenizer plate comprises a homogenizer plate inlet side, a homogenizer plate outlet side and a plurality of through holes extending through the homogenizer plate, and the screen support plate is positioned upstream and adjacent to the homogenizer plate inlet side, the screen support plate comprising a screen support plate inlet side, a screen support plate outlet side, and a plurality of screen support plate openings extending through the screen support plate, wherein the plurality of screen support plate openings are configured to align with the non-circular through holes extending through the homogenizer plate. In some embodiments, the screen support plate openings are elliptical and the homogenizer through-holes are non-circular.

The method in some embodiments may further comprise passing the feed stream of material that has passed through the homogenizer plate through a honeycomb extrusion die having an inlet face comprising feed holes and an outlet face comprising discharge openings, the discharge openings being configured to form a honeycomb extrudate from the feed stream of material flowing through the honeycomb extrusion die.

In some method embodiments, at least some or each of the homogenizer plate through holes are hexagonally-shaped and surrounded by homogenizer plate frame material. In some method embodiments, the screen support plate openings do not overlap with the homogenizer plate frame material that surround each of the hexagonally-shaped homogenizer through holes.

In some method embodiments, the screen support plate openings are elliptical. In some method embodiments, the screen support plate openings are arranged in hexagonal arrays, each array surrounded by screen support plate frame material. In some method embodiments, the hexagonal arrays are arranged to align with the hexagonally-shaped homogenizer through holes. In some method embodiments, the screen support plate openings do not overlap with the homogenizer plate frame material. In some method embodiments, when material is extruded through the honeycomb extrusion apparatus to form a honeycomb body there is a pressure drop over the homogenizer plate that is less than a pressure drop compared to a screen support plate and homogenizer with circular holes.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment of the disclosure. Furthermore, the particular features, structures, materials, or characteristics may be combined in any suitable manner in one or more embodiments.

Although the disclosure herein provided a description with reference to particular embodiments, it is to be understood that these embodiments are merely illustrative of the principles and applications of the disclosure. It will be apparent to those skilled in the art that various modifications and variations can be made to the present disclosure without departing from the spirit and scope thereof. Thus, it is intended that the present disclosure include modifications and variations that are within the scope of the appended claims and their equivalents.

What is claimed is:

1. A ceramic honeycomb extrusion apparatus comprising:
a honeycomb extrusion die having an inlet face comprising feed holes and an outlet face comprising discharge openings, the discharge openings configured to form a honeycomb extrudate from a stream of material flowing through the honeycomb extrusion die;
a homogenizer plate positioned upstream from the inlet face of the extrusion die, the homogenizer plate comprising a homogenizer plate inlet side, a homogenizer plate outlet side and a plurality of through holes extending through the homogenizer plate, each of the through holes surrounded by homogenizer plate frame material;
a screen support plate positioned upstream and adjacent to the homogenizer plate inlet side, the screen support plate comprising a screen support plate inlet side, a screen support plate outlet side, and a plurality of screen support plate openings extending through the screen support plate, wherein the plurality of screen support plate openings are configured to align with the through holes extending through the homogenizer plate, comprise a greater number of screen support plate openings than the plurality of through holes extending through the homogenizer plate and wherein the screen support plate openings do not overlap with the homogenizer plate frame material; and
a screen positioned upstream and adjacent to the screen support inlet side, the screen comprising a screen inlet side and a screen outlet side.

2. The ceramic honeycomb extrusion apparatus of claim 1, wherein the plurality of homogenizer plate through holes includes a number of homogenizer plate through holes and there is a ratio of the number of screen support plate openings to the number of homogenizer plate through holes in a range of from 4:1 to 40:1.

3. The ceramic honeycomb extrusion apparatus of claim 2, the through holes extending through the homogenizer plate are non-circular in shape.

4. The ceramic honeycomb extrusion apparatus of claim 3, wherein the screen support plate openings are non-circular in shape and the through holes extending through the homogenizer plate are hexagonally shaped.

5. The ceramic honeycomb extrusion apparatus of claim 4, wherein the screen support plate openings are elliptical in shape and arranged in hexagonal arrays surrounded by screen support plate frame material.

6. The ceramic honeycomb extrusion apparatus of claim 4, wherein the hexagonal arrays are arranged to align with the hexagonally-shaped homogenizer through holes.

7. The ceramic honeycomb extrusion apparatus of claim 6, comprising a plurality of screen support plates.

8. The ceramic honeycomb extrusion apparatus of claim 3, wherein the screen support plate openings in each one of the plurality of screen support plates is larger than the screen support plate openings in another of the screen support plates.

9. The ceramic honeycomb extrusion apparatus of claim 5, wherein the screen support plate has an open area that is greater than a screen support plate with circular openings.

10. The ceramic honeycomb extrusion apparatus of claim 3, wherein when material is extruded through the honeycomb extrusion apparatus to form a honeycomb body there is a pressure drop over the homogenizer plate that is less than a pressure drop compared to a screen support plate having circular openings and homogenizer plate having circular through holes.

11. A method of extruding a ceramic honeycomb body, the method comprising:
directing a feed stream of batch material along an extrusion path through a screen supported by a screen support plate and then through a homogenizer plate,
wherein the homogenizer plate comprises a homogenizer plate inlet side, a homogenizer plate outlet side and a plurality of through holes extending through the homogenizer plate, and the screen support plate is positioned upstream and adjacent to the homogenizer plate inlet side, the screen support plate comprising a screen support plate inlet side, a screen support plate outlet side, and a plurality of screen support plate openings extending through the screen support plate, wherein the plurality of screen support plate openings are configured to align with the through holes extending through the homogenizer plate and comprise a greater number of screen support plate openings than the plurality of through holes extending through the homogenizer plate.

12. The method of claim 11, further comprising passing the feed stream of material that has passed through the homogenizer plate through a honeycomb extrusion die having an inlet face comprising feed holes and an outlet face comprising discharge openings, the discharge openings being configured to form a honeycomb extrudate from the feed stream of material flowing through the honeycomb extrusion die.

13. The method of claim 12, wherein each of the homogenizer plate through holes are non-circular in shape and surrounded by homogenizer plate frame material.

14. The method of claim 13, wherein the screen support plate openings do not overlap with the homogenizer plate frame material that surround the homogenizer through holes.

15. The method of claim 14, wherein the screen support plate openings are elliptical in shape and the homogenizer plate through holes are hexagonal in shape.

16. The method of claim 15, wherein the screen support plate openings elliptical in shape and are arranged in hexagonal arrays surrounded by screen support plate frame material.

17. The method of claim 16, wherein the hexagonal arrays are arranged to align with the hexagonally-shaped homogenizer through holes.

18. The method of claim 17, wherein the screen support plate openings do not overlap with the homogenizer plate frame material.

19. The method of claim 13, wherein when material is extruded through the honeycomb extrusion apparatus to form a honeycomb body there is a pressure drop over the homogenizer plate that is less than a pressure drop compared to a screen support plate and homogenizer with circular holes.

20. The method of claim 11, wherein the plurality of screen support plate openings includes a number of screen support plate openings and the plurality of homogenizer plate through holes comprises a number of homogenizer plate through holes, and there is a ratio of the number of screen support plate openings to the number of homogenizer plate through holes in a range of from 4:1 to 40:1.
